(19) United States
(12) Patent Application Publication
(10) Pub. No.: US 2013/0099419 A1
(43) Pub. Date: Apr. 25, 2013

(54) CONVERTIBLE TWO PIECE SIDEPLATE

(71) Applicants: Neal G. Sehm, Akron, OH (US); Josef Kostelenski, Tallmadge, OH (US)

(72) Inventors: Neal G. Sehm, Akron, OH (US); Josef Kostelenski, Tallmadge, OH (US)

(21) Appl. No.: 13/280,459

(22) Filed: Oct. 25, 2011

(51) Int. Cl. B29C 35/00

(52) U.S. Cl. 264/326; 425/46

(57) ABSTRACT

Provided is a tire mold. The tire mold may comprise a top primary plate, a bottom primary plate, a first sidewall mold part, and a second sidewall mold part. The first sidewall mold part may comprise a first sidewall mold plate adapted for interchangeable engagement with both the top primary plate and the bottom primary plate, or a first sidewall removable component adapted for interchangeable engagement with both the top primary plate and the bottom primary plate. The second sidewall mold part may comprise a second interchangeable sidewall mold plate adapted for interchangeable engagement with both the top primary plate and the bottom primary plate, or a second sidewall removable component adapted for interchangeable engagement with both the top primary plate and the bottom primary plate.

### TECHNICAL FIELD

The present subject matter relates generally to an apparatus and process for changing a sidewall insert of a tire mold. More, specifically, the present subject matter relates to a convertible two piece sideplate for a tire mold and a process for using same.

### BACKGROUND

A sidewall of a tire often bears one or more marks or molded elements which may include, but are not limited to, a Department of Transportation code, an E-mark, a mold serial number, manufacturer identification, plant of manufacture, date of manufacture, a trademark, a mark identifying the type of tire, size, loading rating, speed capability, decorative elements, or other elements. Typically, these one or more a marks or molded elements are molded onto or into the sidewall of the tire as the tire is cured in a tire mold using cut-outs or raised portions corresponding to the markings on the mold.

Tire molding equipment may comprise a clam shell type mold having a top and bottom mold sections or, alternatively, comprise a segmented type mold having individual tread mold segments fastened on the opposing upper mold frame and/or lower mold frames. In molds of these types, as the sidewall information or characteristics of the tire changes, a mold having different sidewall information is used. In the past, providing different sidewall information required replacement of the tire sidewall molds in a labor intensive mold dismantling procedure which produced considerable losses of production or time or both.

Previous attempts to develop an apparatus and process for replacing or changing a tire sidewall mold have comprised a one piece sideplate. In these attempts, a one piece sideplate has been dedicated to either the top or bottom half of the mold.

It remains desirable to develop an apparatus and process for replacing or changing a tire sidewall mold providing the ability to change the intended outboard side of the tire from the top to the bottom of the mold or from the bottom to the top of the mold. It is also desirable to provide the ability to change information on an existing tire sidewall mold sideplate without loss of mold dimension.

### SUMMARY

Provided is a tire mold. The tire mold may comprise a top primary plate, a bottom primary plate, a first sidewall mold part, and a second sidewall mold part. The first sidewall mold part may comprise a first sidewall mold plate adapted for interchangeable engagement with both the top primary plate and the bottom primary plate, or a first sidewall removable component adapted for interchangeable engagement with both the top primary plate and the bottom primary plate. The second sidewall mold part may comprise a second interchangeable sidewall mold plate adapted for interchangeable engagement with both the top primary plate and the bottom primary plate, or a second sidewall removable component adapted for interchangeable engagement with both the top primary plate and the bottom primary plate.

Further provided is process for molding a tire. The process for molding a tire may comprise providing a tire mold and curing an uncured tire in said mold. The tire mold may comprise a top primary plate, a bottom primary plate, a first sidewall mold part, and a second sidewall mold part. The first sidewall mold part may comprise a first sidewall mold plate adapted for interchangeable engagement with both the top primary plate and the bottom primary plate, or a first sidewall removable component adapted for interchangeable engagement with both the top primary plate and the bottom primary plate. The second sidewall mold part may comprise a second interchangeable sidewall mold plate adapted for interchangeable engagement with both the top primary plate and the bottom primary plate, or a second sidewall removable component adapted for interchangeable engagement with both the top primary plate and the bottom primary plate.

Further provided is a tire mold. The tire mold may comprise a top primary plate, a bottom primary plate, a first tread mold plate engaged with the top plate, a second tread mold plate engaged with the bottom plate, a first sidewall mold plate engaged with the top primary plate, a second sidewall mold plate engaged with the bottom primary plate, a first sidewall removable component adapted for interchangeable engagement with both the first sidewall mold plate and the second sidewall mold plate, a second sidewall removable component adapted for interchangeable engagement with both the first sidewall mold plate and the second sidewall mold plate, a first bead mold ring, and a second bead mold ring. The second sidewall removable component may be interchangeable with the first sidewall removable component.

### BRIEF DESCRIPTION OF THE DRAWINGS

FIG. 1 is a radial section of one embodiment of a clam shell mold.

FIG. 2 is the radial section of the embodiment of a clam shell mold shown in FIG. 1, with the sidewall mold plate swapped.

FIG. 3 is a radial section of another embodiment of a clam shell mold.

FIG. 4 is the radial section of the embodiment of a clam shell mold shown in FIG. 3, with the sidewall removable components swapped.

FIG. 5 is a radial section of one embodiment of a segmented type mold.

FIG. 6 is the radial section of the embodiment of a segmented type mold shown in FIG. 5, with the sidewall mold plates swapped.

### DETAILED DESCRIPTION

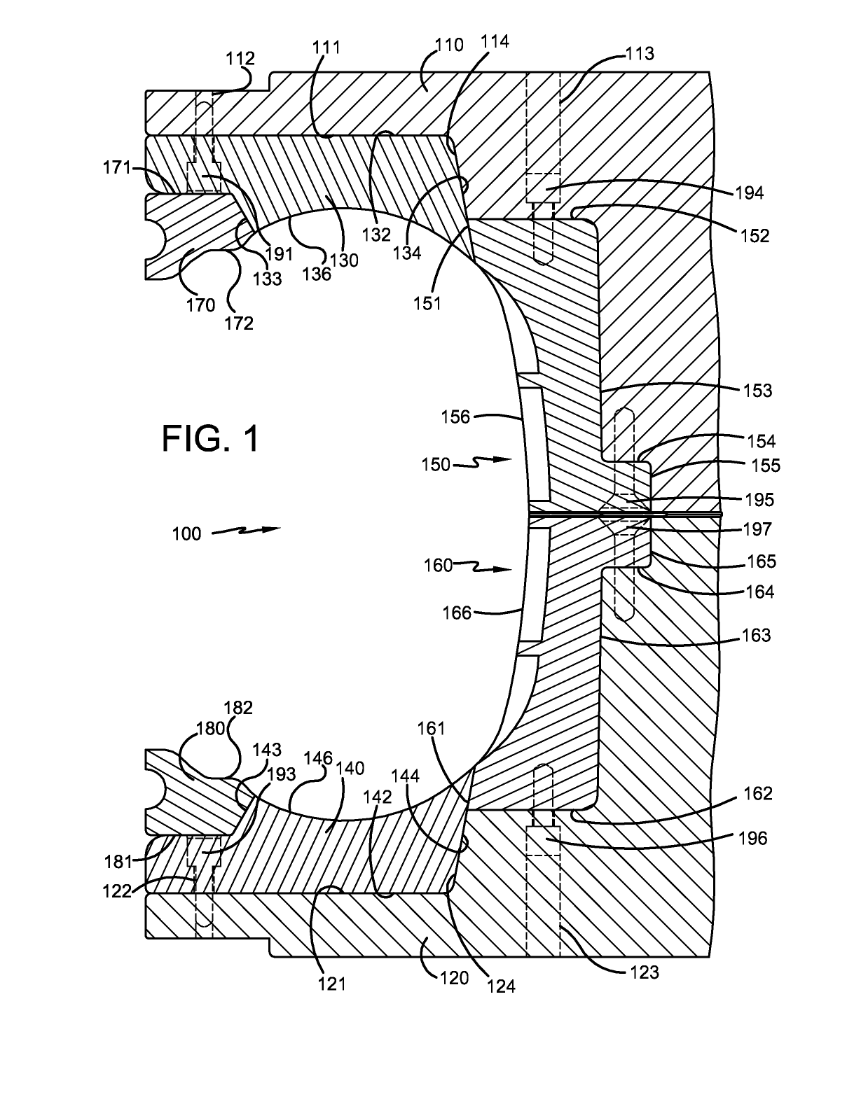

Reference will be made to the drawings, FIGS. 1-6, wherein the showings are only for purposes of illustrating certain embodiments of a convertible two piece sideplate and a process for using same.

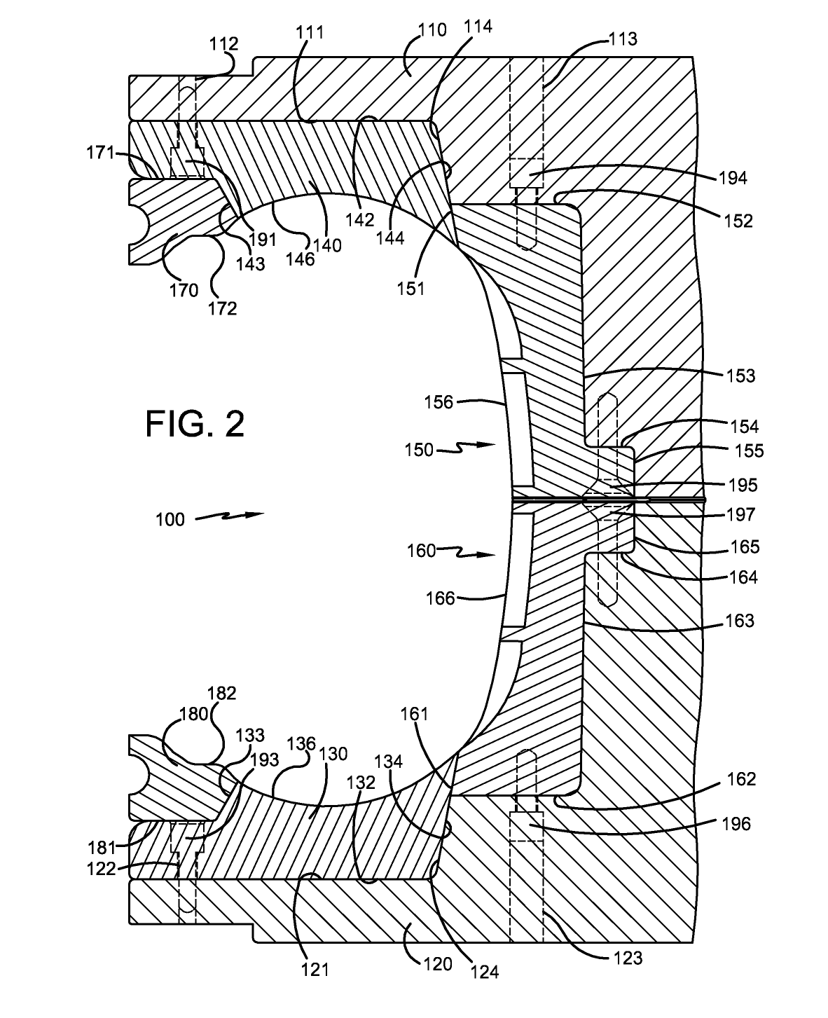

FIGS. 1 and 2 show a clam shell mold 100. The clam shell mold 100 comprises a first or top primary plate 110, a second or bottom primary plate 120, a first or top sidewall mold plate 130, and a second or bottom sidewall mold plate 140. As used herein, the terms “top” and “bottom” are arbitrary as the mold may have any of a wide variety of orientations; the terms “top” and “bottom” are not intended to be limiting but rather to correspond to the orientations shown in the Figures.

The top primary plate 110 provides a substantially rigid structure to which other components of the clam shell mold 100 may be engaged. As used herein, “substantially rigid” refers to the material and geometry of the part and the fact that, while the part is resists substantial deformation, the forces and temperatures that a mold undergoes are very high and may produce some stresses high enough to shift engaged elements slightly and elastically. The top primary plate 110 may comprise a hole, a slot, a groove, a surface, or combinations thereof to facilitate engagement with other components of the clam shell mold 100. In the embodiment shown in FIGS. 1 and 2, the top primary plate 110 comprises first surface 111, a threaded hole 112, a non-threaded hole 113, and a second surface 114.

The bottom primary plate 120 provides a substantially rigid structure to which other components of the clam shell mold 100 may be engaged. The bottom primary plate 120 may comprise a hole, a slot, a groove, a surface, or combinations thereof to facilitate engagement with other components of the clam shell mold 100. In the embodiment shown in FIGS. 1 and 2, the bottom primary plate 120 comprises first surface 121, a threaded hole 122, a non-threaded hole 123, and a second surface 124.

A sidewall mold plate is a part used to mold the sidewall of a tire. Because a tire has two sides, the tire sides may be referred to as an inboard side and an outboard side. While in some limited cases, the inboard side and outboard side of a tire may be symmetric to one another, in general this is not so. Each of the two tire sides will have a sidewall. Accordingly, a tire will comprise an inboard sidewall and an outboard sidewall. In order to mold a tire comprising an inboard sidewall and an outboard sidewall, the mold for the tire must similarly comprise an inboard sidewall mold and an outboard sidewall mold.

A sidewall mold may comprise a single unitary plate or may comprise an assemblage of parts. Where both the inboard sidewall mold and the outboard sidewall mold each comprises a single unitary plate, it is possible to design each of the inboard sidewall mold and an outboard sidewall mold to be interchangeable with the other sidewall mold. As used herein, interchangeable means that the parts in question may replace one another in the mold such that they may be readily swapped for one another. Interchangeable mold parts will have substantially identical surfaces for engagement with the mold components that they directly engage such that the directly engaged mold components are adapted to accept either one of the interchangeable parts. Where both the inboard sidewall mold and the outboard sidewall mold each comprise an assemblage of parts, it is possible to design each of the inboard sidewall mold and an outboard sidewall mold to comprise a part that is interchangeable with a complementary part in the other sidewall mold.

Referring to the embodiment shown in FIG. 1, the top sidewall mold plate 130 is engaged with top primary plate 110. In the embodiment shown in FIG. 1, the top sidewall mold plate 130 is engaged with top primary plate 110 by a mechanical fastener 191. As noted elsewhere herein, in other embodiments, mold components may be engaged by other means. The top sidewall mold plate 130 comprises a first top sidewall mold plate engagement surface 132, and a first top sidewall mold plate molding surface 136. The first top sidewall mold plate engagement surface 132 is a surface adapted for engagement with the top primary plate 110. As shown, the first top sidewall mold plate engagement surface 132 is engaged with the first surface 111 of top primary plate 110. The top sidewall mold plate 130 further comprises a top bead mold ring engagement surface 133. The top bead mold ring engagement surface 133 is a surface adapted for engagement with the top bead mold ring 170. The top sidewall mold plate 130 further comprises a second top sidewall mold plate engagement surface 134. The second top sidewall mold plate engagement surface 134 is a surface adapted for engagement with the top primary plate 110. As shown, the second top sidewall mold plate engagement surface 134 is engaged with the second surface 114 of top primary plate 110. The first top sidewall mold plate molding surface 136 is adapted for engagement with an uncured tire (not shown) to be cured in the tire mold 100. During curing of an uncured tire (not shown), the first top sidewall mold plate molding surface 136 functions to mold the top sidewall (not shown) of the tire (not shown).

Referring to the embodiment shown in FIG. 1, the bottom sidewall mold plate 140 is engaged with bottom primary plate 120. In the embodiment shown in FIG. 1, the bottom sidewall mold plate 140 is engaged with bottom primary plate 120 by a mechanical fastener 193. The bottom sidewall mold plate 140 comprises a first bottom sidewall mold plate engagement surface 142, and a first bottom sidewall mold plate molding surface 146. The first bottom sidewall mold plate engagement surface 142 is a surface adapted for engagement with the bottom primary plate 120. As shown, the first top sidewall mold plate engagement surface 142 is engaged with the first surface 121 of bottom primary plate 120. The bottom sidewall mold plate 140 further comprises a bottom bead mold ring engagement surface 143. The bottom bead mold ring engagement surface 143 is a surface adapted for engagement with the bottom bead mold ring 180. The bottom sidewall mold plate 140 further comprises a second bottom sidewall mold plate engagement surface 144. The second bottom sidewall mold plate engagement surface 144 is a surface adapted for engagement with the bottom primary plate 120. As shown, the second bottom sidewall mold plate engagement surface 144 is engaged with the second surface 124 of bottom primary plate 120. The first bottom sidewall mold plate molding surface 146 is adapted for engagement with an uncured tire (not shown) to be cured in the tire mold 100. During curing of an uncured tire (not shown), the first bottom sidewall mold plate molding surface 146 functions to mold the bottom sidewall (not shown) of the tire (not shown).

In the embodiment shown FIGS. 1 and 2, the clam shell mold 100 further comprises a top tread mold plate 150, a bottom tread mold plate 160, a top bead mold ring 170, and a bottom bead mold ring 180. Other embodiments of tire molds comprising a convertible two piece sideplate for a tire mold may or may not include one or more of a top tread mold plate 150, a bottom tread mold plate 160, a top bead mold ring 170, and/or a bottom bead mold ring 180.

The top tread mold plate 150 is engaged with top primary plate 110. In the embodiment shown in FIGS. 1 and 2, the top tread mold plate 150 is engaged with top primary plate 110 by a mechanical fastener 194 and mechanical fastener 195. The top tread mold plate 150 comprises a top sidewall mold plate engagement surface 151, a first top primary plate engagement surface 152, a second top primary plate engagement surface 153, a third top primary plate engagement surface 154, a fourth top primary plate engagement surface 155, and a top tread mold plate molding surface 156. While the embodiment shown in FIGS. 1 and 2 shows a plurality of engagement surfaces 152, 153, 154, 155 separated by fillets by which the top tread mold plate 150 is engaged with the top primary plate 110, there are many acceptable alternative embodiments in which engagement is via other surface configurations, a single surface, or is indirect engagement through intermediate components. Similarly, while the embodiment shown in FIGS. 1 and 2 shows the top tread mold plate 150 engaged with the top sidewall mold plate 130 via a top sidewall mold plate engagement surface 151, there are many acceptable alternative embodiments in which engagement is via other surface configurations, or is indirect engagement through intermediate components. The top tread mold plate molding surface 156 is adapted for engagement with an uncured tire (not shown) to be cured in the tire mold 100. During curing of an uncured tire (not shown), the top tread mold plate molding surface 156 functions to mold the top portion of the tread (not shown) of the tire (not shown).

The bottom tread mold plate 160 comprises is engaged with bottom primary plate 120. In the embodiment shown in FIG. 1, the bottom tread mold plate 160 is engaged with top primary plate 120 by a mechanical fastener 196 and mechanical fastener 197. The bottom tread mold plate 160 comprises a bottom sidewall mold plate engagement surface 161, a first bottom primary plate engagement surface 162, a second top primary plate engagement surface 163, a third bottom primary plate engagement surface 164, a fourth bottom primary plate engagement surface 165, and a bottom tread mold plate molding surface 166. While the embodiment shown in FIGS. 1 and 2 shows a plurality of engagement surfaces 162, 163, 164, 165 separated by fillets by which the bottom tread mold plate 160 is engaged with the bottom primary plate 120, there are many acceptable alternative embodiments in which engagement is via other surface configurations, a single surface, or is indirect engagement through intermediate components. Similarly, while the embodiment shown in FIG. 1 shows the bottom tread mold plate 160 engaged with the bottom sidewall mold plate 140 via a bottom sidewall mold plate engagement surface 161, there are many acceptable alternative embodiments in which engagement is via other surface configurations, or is indirect engagement through intermediate components. The bottom tread mold plate molding surface 166 is adapted for engagement with an uncured tire (not shown) to be cured in the tire mold 100. During curing of an uncured tire (not shown), the bottom tread mold plate molding surface 156 functions to mold the bottom portion of the tread (not shown) of the tire (not shown).

In FIG. 1, the top bead mold ring 170 is engaged with top sidewall mold plate 130. The top bead mold ring 170 comprises a top sidewall mold plate engagement surface 171 and a top bead molding surface 172. The top bead molding surface 172 is adapted for engagement with an uncured tire (not shown) to be cured in the tire mold 100. During curing of an uncured tire (not shown), the top bead molding surface 172 functions to mold the top bead (not shown) of the tire (not shown).

In FIG. 1, the bottom bead mold ring 180 is engaged with bottom sidewall mold plate 140. The bottom bead mold ring 180 comprises a bottom sidewall mold plate engagement surface 181 and a bottom bead molding surface 182. The bottom bead molding surface 182 is adapted for engagement with an uncured tire (not shown) to be cured in the tire mold 100. During curing of an uncured tire (not shown), the bottom bead molding surface 182 functions to mold the top bead (not shown) of the tire (not shown).

Referring now to FIGS. 1 and 2, the top sidewall mold plate 130 and the bottom sidewall mold plate 140 are interchangeable. All of the surfaces adapted for engagement with the top sidewall mold plate 130, that is, surfaces 111, 114, 151, and 171, are adapted for engagement with the bottom sidewall mold plate 140. All of the surfaces adapted for engagement with the bottom sidewall mold plate 140, that is, surfaces 121, 124, 161, and 181, are adapted for engagement with the bottom sidewall mold plate 130. All of the surfaces of the top sidewall mold plate 130 adapted for engagement with the top primary plate 110, that is, surfaces 132 and 134, are adapted for engagement with the bottom primary plate 120. The surface of the top sidewall mold plate 130 adapted for engagement with the top tread mold plate 150, that is, surface 134, is adapted for engagement with the bottom tread mold plate 160. The surface of the top sidewall mold plate 130 adapted for engagement with the top bead mold ring 170, that is surface 133, is adapted for engagement with the bottom bead mold ring 180. All of the surfaces of the bottom sidewall mold plate 140 adapted for engagement with the bottom primary plate 120, that is, surfaces 142 and 144, are adapted for engagement with the top primary plate 110. The surface of the bottom sidewall mold plate 140 adapted for engagement with the bottom tread mold plate 160, that is, surface 144, is adapted for engagement with the top tread mold plate 150. The surface of the bottom sidewall mold plate 140 adapted for engagement with the bottom bead mold ring 180, that is, surface 143, is adapted for engagement with the top bead mold ring 170. Accordingly, as shown in FIG. 2, the top sidewall mold plate 130 and the bottom sidewall mold plate 140 may be swapped from the positions shown in FIG. 1.

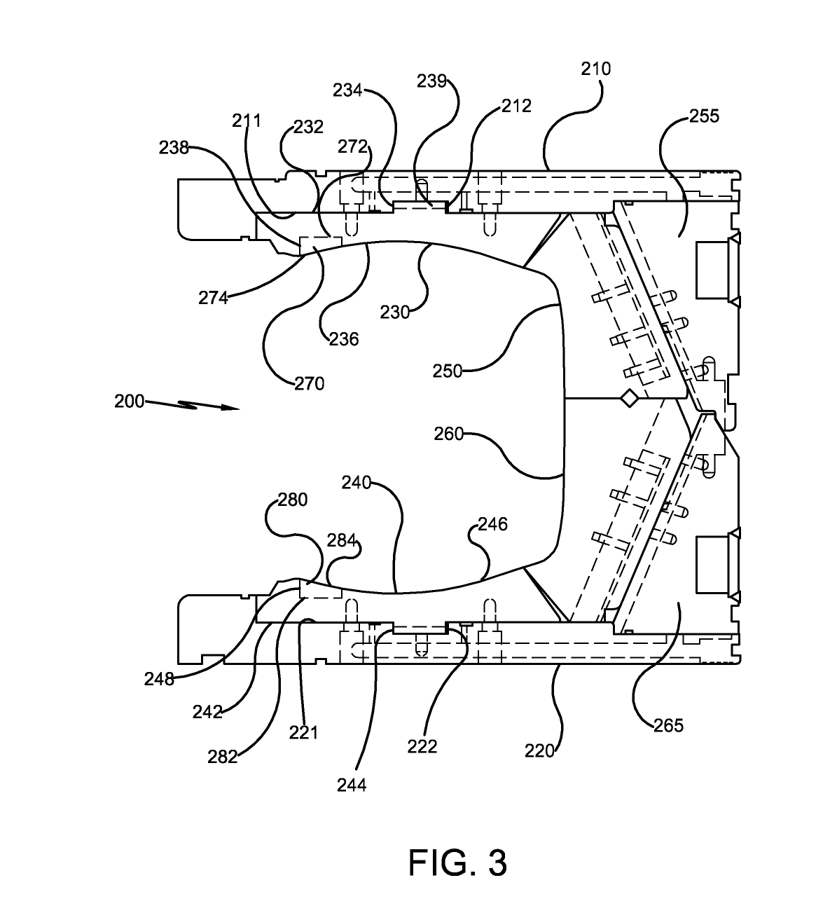

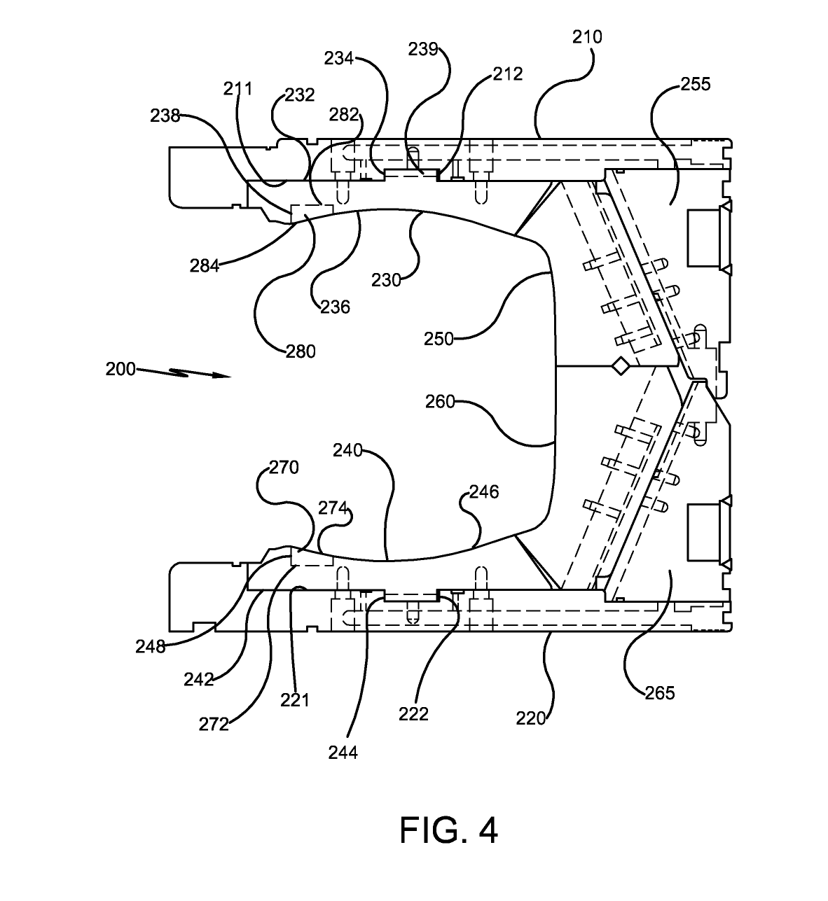

FIGS. 3 and 4 show a clam shell mold 200. The clam shell mold 200 comprises a first or top primary plate 210, a second or bottom primary plate 220, a first or top sidewall mold plate 230, and a second or bottom sidewall mold plate 240.

The top primary plate 210 provides a substantially rigid structure to which other components of the clam shell mold 200 may be engaged. The top primary plate 210 may comprise a hole, a slot, a groove, a surface, or combinations thereof to facilitate engagement with other components of the clam shell mold 200. In the embodiment shown in FIGS. 3 and 4, the top primary plate 210 comprises first surface 211, and a slot 212.

The bottom primary plate 220 provides a substantially rigid structure to which other components of the clam shell mold 200 may be engaged. The bottom primary plate 220 may comprise a hole, a slot, a groove, a surface, or combinations thereof to facilitate engagement with other components of the clam shell mold 200. In the embodiment shown in FIGS. 3 and 4, the bottom primary plate 220 comprises first surface 221, and a slot 222.

Referring to the embodiment shown in FIGS. 3 and 4, the top sidewall mold plate 230 is engaged with top primary plate 210. In the embodiment shown in FIG. 3, the top sidewall mold plate 230 is engaged with top primary plate 210 by a tongue 234 adapted to engage slot 222. Tongue 234 may be flat or comprise waves, grooves 239, or other features. As noted elsewhere herein, in other embodiments, mold components may be engaged by other means including but not limited to mechanical fasteners. The top sidewall mold plate 230 comprises a first top sidewall mold plate engagement surface 232, a top sidewall mold plate removable component engagement region 238, and a first top sidewall mold plate molding surface 236. The first top sidewall mold plate engagement surface 232 is a surface adapted for engagement with the top primary plate 210. As shown, the first top sidewall mold plate engagement surface 232 is engaged with the first surface 211 of top primary plate 210. The top sidewall mold plate removable component engagement region 238 is a region of the top sidewall mold plate 230 adapted to engage a top sidewall removable component 270. The first top sidewall mold plate molding surface 236 is adapted for engagement with an uncured tire (not shown) to be cured in the tire mold 200. During curing of an uncured tire (not shown), the first top sidewall mold plate molding surface 236 functions to mold part of the top sidewall (not shown) of the tire (not shown).

Referring to the embodiment shown in FIGS. 3 and 4, the bottom sidewall mold plate 240 is engaged with bottom primary plate 220. In the embodiment shown in FIG. 3, the bottom sidewall mold plate 240 is engaged with bottom primary plate 220 by a tongue 244 adapted to engage slot 222. As noted elsewhere herein, in other embodiments, mold components may be engaged by other means including but not limited to mechanical fasteners. The bottom sidewall mold plate 240 comprises a first bottom sidewall mold plate engagement surface 242, a bottom sidewall mold plate removable component engagement region 248, and a first bottom sidewall mold plate molding surface 246. The first bottom sidewall mold plate engagement surface 242 is a surface adapted for engagement with the top primary plate 220. As shown, the first bottom sidewall mold plate engagement surface 242 is engaged with the first surface 221 of top primary plate 220. The bottom sidewall mold plate removable component engagement region 248 is a region of the bottom sidewall mold plate 240 adapted to engage a bottom sidewall removable component 280. The first bottom sidewall mold plate molding surface 246 is adapted for engagement with an uncured tire (not shown) to be cured in the tire mold 200. During curing of an uncured tire (not shown), the first bottom sidewall mold plate molding surface 246 functions to mold part of the bottom sidewall (not shown) of the tire (not shown).

In the embodiment shown FIGS. 3 and 4, the clam shell mold 200 further comprises a top tread mold plate 250, a bottom tread mold plate 260, a top mold backing component 255, and a bottom mold backing component 265. Other embodiments of tire molds comprising a convertible two piece sideplate for a tire mold may or may not include one or more of a top tread mold plate 250, a bottom tread mold plate 260, a top mold backing component 255, and/or a bottom mold backing component 265.

Referring now to FIGS. 3 and 4, the top sidewall removable component 270 and the bottom sidewall removable component 280 are interchangeable.

Top sidewall removable component 270 comprises an engagement surface 272 and a molding surface 274. Molding surface 274 is adapted for engagement with an uncured tire (not shown) to be cured in the tire mold 200. During curing of an uncured tire (not shown), molding surface 274 functions to mold part of the sidewall (not shown) of the tire (not shown). The engagement surface 272 is adapted to engage either the top sidewall mold plate removable component engagement region 238 or the bottom sidewall mold plate removable component engagement region 248. As shown in FIG. 3, the top sidewall removable component 270 may be engaged with the top sidewall mold plate 230 so that, during curing, molding surface 274 functions to mold part of the top sidewall (not shown) of the tire (not shown). As shown in FIG. 4, the top sidewall removable component 270 may be engaged with the bottom sidewall mold plate 240 so that, during curing, molding surface 274 functions to mold part of the bottom sidewall (not shown) of the tire (not shown).

Bottom sidewall removable component 280 comprises an engagement surface 282 and a molding surface 284. Molding surface 284 is adapted for engagement with an uncured tire (not shown) to be cured in the tire mold 200. During curing of an uncured tire (not shown), molding surface 284 functions to mold part of the sidewall (not shown) of the tire (not shown). The engagement surface 282 is adapted to engage either the top sidewall mold plate removable component engagement region 238 or the bottom sidewall mold plate removable component engagement region 248. As shown in FIG. 3, the bottom sidewall removable component 280 may be engaged with the bottom sidewall mold plate 240 so that, during curing, molding surface 284 functions to mold part of the bottom sidewall (not shown) of the tire (not shown). As shown in FIG. 4, the bottom sidewall removable component 280 may be engaged with the top sidewall mold plate 230 so that, during curing, molding surface 284 functions to mold part of the top sidewall (not shown) of the tire (not shown).

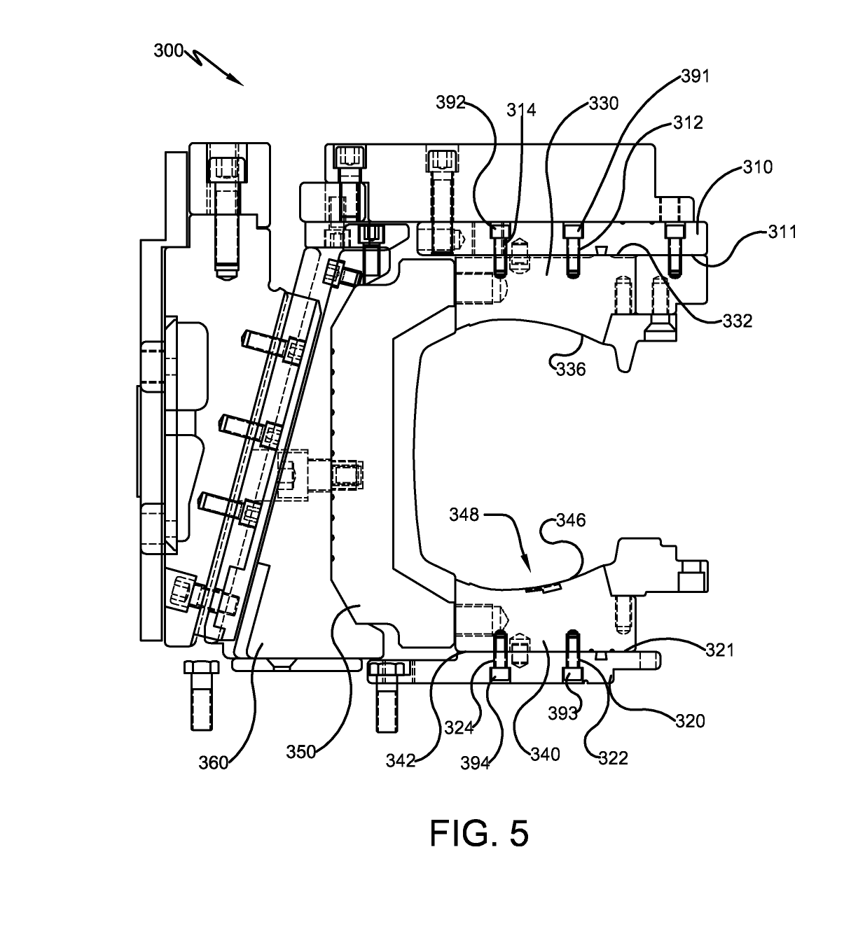

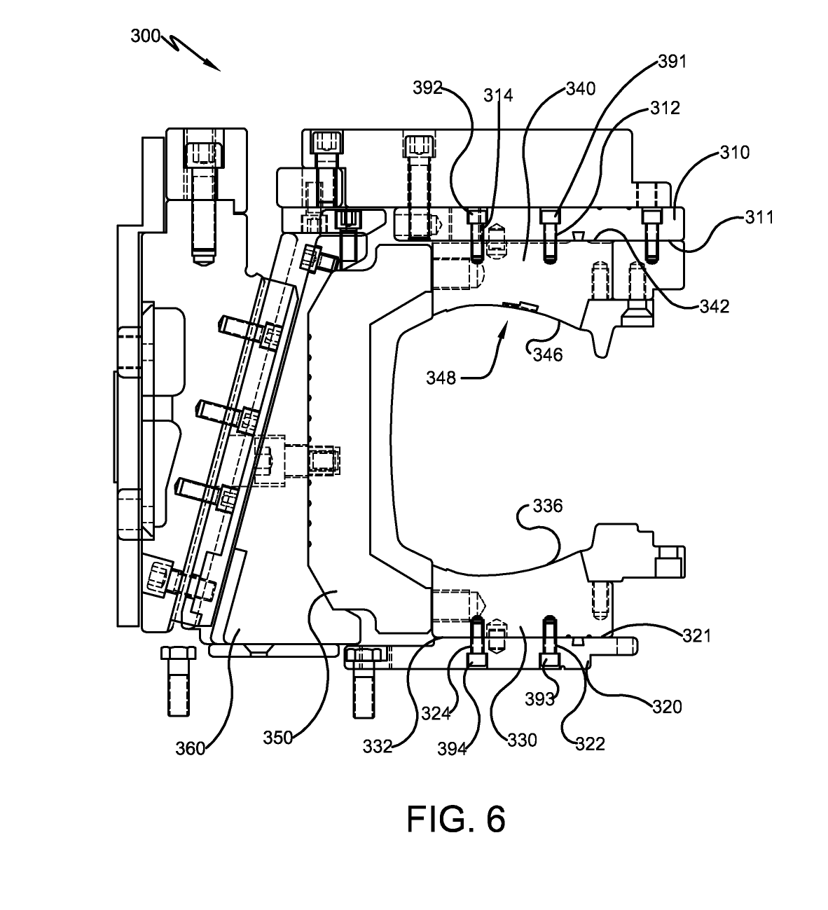

FIGS. 5 and 6 show a segmented type mold 300. The segmented type mold 300 comprises a first or top primary plate 310, a second or bottom primary plate 320, a first or top sidewall mold plate 330, and a second or bottom sidewall mold plate 340.

The top primary plate 310 provides a substantially rigid structure to which other components of the segmented type mold 300 may be engaged. The top primary plate 310 may comprise a hole, a slot, a groove, a surface, or combinations thereof to facilitate engagement with other components of the segmented type mold 300. In the embodiment shown in FIGS. 5 and 6, the top primary plate 310 comprises first surface 311, a first unthreaded hole 312, and a second unthreaded hole 314.

The bottom primary plate 320 provides a substantially rigid structure to which other components of the segmented type mold 300 may be engaged. The bottom primary plate 320 may comprise a hole, a slot, a groove, a surface, or combinations thereof to facilitate engagement with other components of the segmented type mold 300. In the embodiment shown in FIGS. 5 and 6, the bottom primary plate 320 comprises first surface 321, a first unthreaded hole 322, and a second unthreaded hole 324.

Referring to the embodiment shown in FIG. 5, the top sidewall mold plate 330 is engaged with top primary plate 310. In the embodiment shown in FIG. 5, the top sidewall mold plate 330 is engaged with top primary plate 310 by mechanical fasteners 391 and 392. As noted elsewhere herein, in other embodiments, mold components may be engaged by other means including but not limited to a slot, a tongue, or a groove. The top sidewall mold plate 330 comprises a first top sidewall mold plate engagement surface 332, and a first top sidewall mold plate molding surface 336. The first top sidewall mold plate engagement surface 332 is a surface adapted for engagement with the top primary plate 310. As shown, the first top sidewall mold plate engagement surface 332 is engaged with the first surface 311 of top primary plate 310. The first top sidewall mold plate molding surface 336 is adapted for engagement with an uncured tire (not shown) to be cured in the tire mold 300. During curing of an uncured tire (not shown), the first top sidewall mold plate molding surface 336 functions to mold part of the top sidewall (not shown) of the tire (not shown). In other embodiments not shown here, the top sidewall mold plate 330 may comprise a removable component engagement region (not shown) adapted to engage a top sidewall removable component (not shown).

Referring to the embodiment shown in FIG. 5, the bottom sidewall mold plate 340 is engaged with bottom primary plate 320. In the embodiment shown in FIG. 5, the bottom sidewall mold plate 340 is engaged with bottom primary plate 320 by mechanical fasteners 393 and 394. As noted elsewhere herein, in other embodiments, mold components may be engaged by other means including but not limited to a slot, a tongue, or a groove. The bottom sidewall mold plate 340 comprises a first bottom sidewall mold plate engagement surface 342 and a first bottom sidewall mold plate molding surface 346. The bottom sidewall mold plate 340 further comprises a molding feature 348. The first bottom sidewall mold plate engagement surface 342 is a surface adapted for engagement with the top primary plate 320. As shown, the first bottom sidewall mold plate engagement surface 342 is engaged with the first surface 221 of top primary plate 320. The first bottom sidewall mold plate molding surface 346 is adapted for engagement with an uncured tire (not shown) to be cured in the tire mold 300. During curing of an uncured tire (not shown), the first bottom sidewall mold plate molding surface 346 functions to mold part of the bottom sidewall (not shown) of the tire (not shown). In other embodiments not shown here, the bottom sidewall mold plate 340 may comprise a removable component engagement region (not shown) adapted to engage a bottom sidewall removable component (not shown).

In the embodiment shown FIGS. 5 and 6, the segmented type mold 300 further comprises a tread mold plate 350, and a mold backing component 360. Other embodiments of tire molds comprising a convertible two piece sideplate for a tire mold may or may not include additional components.

Referring now to FIGS. 5 and 6, the top sidewall mold plate 330 and the bottom sidewall mold plate 340 are interchangeable.

As shown in FIG. 5, the top sidewall mold plate 330 may be engaged with the top primary plate 310 so that, during curing, molding surface 336 functions to mold the top sidewall (not shown) of the tire (not shown). As shown in FIG. 6, the top sidewall mold plate 330 may be engaged with the bottom primary plate 320 so that, during curing, molding surface 336 functions to mold the bottom sidewall (not shown) of the tire (not shown).

As shown in FIG. 5, the bottom sidewall mold plate 340 may be engaged with the bottom primary plate 320 so that, during curing, molding surface 346 functions to mold the bottom sidewall (not shown) of the tire (not shown). As shown in FIG. 6, the bottom sidewall mold plate 340 may be engaged with the top primary plate 310 so that, during curing, molding surface 336 functions to mold the top sidewall (not shown) of the tire (not shown).

Referring again to the embodiments shown in FIGS. 1, 2, 5 and 6, it is possible to change information on a sidewall mold plate without loss of mold dimension. For example a side wall mold plate, 130, 140, 330, 340 can be removed from the mold, and have the information on the molding surface 136, 146, 336, 346 changed by re-machining or otherwise re-cutting the molding surface 136, 146, 336, 346. While such re-machining or otherwise re-cutting the molding surface 136, 146, 336, 346 does result in a loss of material from the mold plate 130, 140, 330, 340, the mold dimension may be preserved without loss by inserting a shim or other spacer between the mold plate, 130, 140, 330, 340 and the mold surface with which it is engaged. By careful selection of the amount of material re-machining or otherwise re-cutting the molding surface 136, 146, 336, 346, and the thickness of the shim or other spacer between the mold plate, 130, 140, 330, 340 and the mold surface with which it is engaged, the it is possible to change information on a sidewall mold plate 130, 140, 330, 340 without loss of mold dimension.

The components of a tire mold as described herein may comprise any of a large variety of materials. The components of a tire mold as described herein may comprise steel, aluminum, an aluminum alloy, a ceramic, or another material.

While the convertible two piece sideplate and process for using same have been described above in connection with certain embodiments, it is to be understood that other embodiments may be used or modifications and additions may be made to the described embodiments for performing the same function of the convertible two piece sideplate and process for using same without deviating therefrom. Further, the convertible two piece sideplate and process for using same may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the convertible two piece sideplate and process for using same. Therefore, the convertible two piece sideplate and process for using same should not be limited to any single embodiment, but rather construed in breadth and scope in accordance with the recitation of the attached claims.

What is claimed is:

1. A tire mold, comprising:
a top primary plate;
a bottom primary plate;
a first sidewall mold part comprising,
a first sidewall mold plate adapted for interchangeable engagement with both the top primary plate and the bottom primary plate, or
a first sidewall removable component adapted for interchangeable engagement with both the top primary plate and the bottom primary plate; and
a second sidewall mold part comprising,
a second interchangeable sidewall mold plate adapted for interchangeable engagement with both the top primary plate and the bottom primary plate, or
a second sidewall removable component adapted for interchangeable engagement with both the top primary plate and the bottom primary plate.

2. The tire mold of claim 1, further comprising a first tread mold plate.

3. The tire mold of claim 2, further comprising a second tread mold plate.

4. The tire mold of claim 3, wherein said first sidewall mold part comprises a first sidewall removable component adapted for interchangeable engagement with both the top primary plate and the bottom primary plate.

5. The tire mold of claim 4, wherein said second sidewall mold part comprises a second sidewall removable component adapted for interchangeable engagement with both the top primary plate and the bottom primary plate.

6. The tire mold of claim 5, wherein said first sidewall mold part further comprises a first sidewall mold plate engaged with the top primary plate, said first sidewall mold plate being adapted to interchangably engage the first sidewall removable component and the second sidewall removable component.

7. The tire mold of claim 6, wherein said second sidewall mold part further comprises a second sidewall mold plate engaged with the bottom primary plate, said second sidewall mold plate being adapted to interchangably engage the first sidewall removable component and the second sidewall removable component.

8. The tire mold of claim 7, further comprising a first bead mold ring.

9. The tire mold of claim 8, further comprising a second bead mold ring.

10. A process for molding a tire, comprising:
providing a tire mold, said tire mold comprising,
a top primary plate;
a bottom primary plate;
a first sidewall mold part comprising,
a first sidewall mold plate adapted for interchangeable engagement with both the top primary plate and the bottom primary plate, or
a first sidewall removable component adapted for interchangeable engagement with both the top primary plate and the bottom primary plate; and
a second sidewall mold part comprising,
a second interchangeable sidewall mold plate adapted for interchangeable engagement with both the top primary plate and the bottom primary plate, or
a second sidewall removable component adapted for interchangeable engagement with both the top primary plate and the bottom primary plate; and
curing an uncured tire in said mold.

11. The process for molding a tire of claim 10, wherein said tire mold further comprises a first tread mold plate.

12. The process for molding a tire of claim 11, wherein said tire mold further comprises a second tread mold plate.

13. The process for molding a tire of claim 12, wherein said tire mold comprises a first sidewall removable component adapted for interchangeable engagement with both the top primary plate and the bottom primary plate.

14. The process for molding a tire of claim 13, wherein said tire mold comprises a second sidewall removable component adapted for interchangeable engagement with both the top primary plate and the bottom primary plate.

15. The process for molding a tire of claim 14, wherein said tire mold further comprises a first sidewall mold plate engaged with the top primary plate, said first sidewall mold plate being adapted to interchangably engage the first sidewall removable component and the second sidewall removable component.

16. The process for molding a tire of claim 15, wherein said tire mold further comprises a second sidewall mold plate engaged with the bottom primary plate, said second sidewall mold plate being adapted to interchangably engage the first sidewall removable component and the second sidewall removable component.

17. The process for molding a tire of claim 16, wherein said tire mold further comprises a first bead mold ring.

18. The process for molding a tire of claim 17, wherein said tire mold further comprises a second bead mold ring.

19. The process for molding a tire of claim 18, wherein said tire mold further comprises swapping the positions of the first sidewall removable component and the second sidewall removable component.

20. A tire mold, comprising:
a top primary plate;
a bottom primary plate;
a first tread mold plate engaged with said top primary plate;
a second tread mold plate engaged with said bottom primary plate;
a first sidewall mold plate engaged with said top primary plate;
a second sidewall mold plate engaged with said bottom primary plate;
a first sidewall removable component adapted for interchangeable engagement with both the first sidewall mold plate and the second sidewall mold plate;
a second sidewall removable component adapted for interchangeable engagement with both the first sidewall mold plate and the second sidewall mold plate, said second sidewall removable component being interchangeable with the first sidewall removable component;
a first bead mold ring; and
a second bead mold ring.
